(19) United States
(12) Patent Application Publication
(10) Pub. No.: US 2007/0240157 A1
(43) Pub. Date: Oct. 11, 2007

(54) Method, apparatus, mobile terminal and computer program product for safe application termination in a virtual machine

(75) Inventors: Gergely Herenyi, Budapest (HU); Andras Boros, Budapest (HU); Daniel Fey, Budapest (HU); Jyrki Aarnos, Kangasala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/401,397

(22) Filed: Apr. 10, 2006

(51) Int. Cl. G06F 9/455

(52) U.S. Cl. 718/1

(57) ABSTRACT

A method of providing termination of threads in a virtual machine includes defining one or more of a protected set of code segments and an unprotected set of code segments, deferring termination of a thread that has been identified for termination in response to the thread being located in the protected set, and terminating the thread that has been identified for termination in response to the thread being located in the unprotected set.

### FIELD OF THE INVENTION

Embodiments of the present invention relate generally to safe termination of applications running on a virtual machine and, more particularly, relate to a method, apparatus, and computer program product for providing safe termination of applications such as Java applications running on a virtual machine.

### BACKGROUND OF THE INVENTION

In many communication networks, including wireless communication networks, remote nodes such as computers or mobile terminals are provided with multiple mechanisms by which to open applications for execution. For example, in the context of mobile terminals such as mobile phones in wireless communication networks, it is typical for applications to access and utilize various mobile terminal features such as calling, sending or receiving short messages, browsing, multimedia messaging, etc. If the wireless communication network is not closed, applications can come from different and sometimes untrusted sources. Accordingly, the mobile terminal may be susceptible to deploying malicious or ill-behaving applications. Such malicious or ill-behaving applications can, for example, use up relatively large amounts of memory or consume relatively large amounts of processing power. Thus, it may be beneficial to provide some level of isolation between applications in order to protect well-behaving applications.

One way to protect the well behaving applications from others is to establish a system to detect and monitor the malicious or ill-behaving applications and terminate them forcefully if needed. Accordingly, in such a system, if an application is identified as being a malicious or ill-behaving application, all threads associated with the application must be terminated. A thread is a sequence of a program that runs a certain function within the program. Each thread is one of potentially many such sequences which simultaneously move through code segments of the application. As such, each thread may move from critically important code segments to other non critical code segments while executing methods of a particular application or program. A thread may be a part of an application that appears to be malicious, and therefore is a target for termination, however, a problem may arise if the thread to be terminated happens to be executing a critical code segment or updating a critical data structure at the time of termination. Accordingly, if the system terminates the thread while the thread is executing a critical code segment or updating a critical data structure, corruption or damage may occur to an otherwise well-behaving program.

Open Services Gateway Initiative (OSGi) is an open, common architecture to develop, deploy and manage services on the same virtual machine (VM) cooperatively. A VM is a self-contained operating environment that behaves as if it is a separate computer. For example, Java applets run in a Java VM that has no access to the host operating system. The package and service sharing model of OSGi is a good example of a multi-application platform that may suffer the problems described above. OSGi uses the facilities of an underlying standard Java platform. Java, which is well known in the industry, is extremely portable, flexible and powerful with respect to allowing applications to, for example, access mobile phone features. Thus, Java has been widely used by developers to develop portable applications that can be run on a wide variety of electronic devices or computers without modification. Currently, an OSGi application cannot be both forcefully and safely terminated due to a lack of thread accounting and a lack of means to safely terminate a thread. Current Java application programming interface (API) methods such as “destroy( )”, “stop( )”, and “interrupt( )” have various problems associated with each of them and are therefore not currently suitable for such purposes. Furthermore, some methods for providing isolation between applications that have been developed require alteration of API code and must be hard coded and therefore are not flexible.

Additionally, once an object such as a Java object is no longer referenced it may be reclaimed by a garbage collector of the VM. Classes can declare a “finalize( )” method which is invoked before objects are discarded by the garbage collector, thereby allowing the objects to clean up their state. Upon termination of an application, reclamation of pure Java objects that have no dependencies to any native resources simply frees memory that had been occupied by the objects. However, reclamation of objects that have allocated various non-Java (i.e., native) resources requires extra administration since freeing such objects leaves associated and unneeded native resources alive.

In order to achieve reclamation of native resources of an application, all allocated resources should be properly registered and destroyed upon application termination. Finalizers in their current form are not directly useable for resource reclamation. A finalizer is a piece of code that ensures that certain necessary actions are taken when an acquired resource (such as a file or access to a hardware device) is no longer being used. Finalizers of untrusted classes may contain undesirable kinds of code such as endless loops, etc. Accordingly, promiscuously running finalizers of all objects of a terminated application may cause undesirable effects.

Accordingly, there is a need to provide an improved level of isolation among applications while minimizing communication overhead and complexity and an improved method of selectively running finalizers of objects associated with terminated applications. Additionally, there is a need for a solution that increases flexibility without altering API code.

### BRIEF SUMMARY OF THE INVENTION

A method, apparatus and computer program product are therefore provided that enables Java or other applications to safely terminate a thread in a virtual machine (VM), such as a Java VM serving multiple applications at a time. Accordingly, increased flexibility, security and ease of use may be afforded to mobile terminal users or users of other devices employing VMs.

In one exemplary embodiment, a method and computer program product are disclosed for providing termination of a thread in a virtual machine. In this embodiment, the method and computer program product define one or more of a protected set of code segments and an unprotected set of code segments, defer termination of a thread that has been identified for termination in response to the thread being located in the protected set, and terminate the thread that has been identified for termination in response to the thread being located in the unprotected set.

In another exemplary embodiment, a mobile terminal is provided that is capable of providing termination of a thread in a virtual machine. In this regard, the mobile terminal includes a framework supporting a virtual machine capable of executing applications via threads. The virtual machine includes a thread management module. The thread management module includes a classification element and a termination element. The classification element is capable of defining one or more of a protected set of code segments and an unprotected set of code segments. The termination element is capable of deferring termination of a thread that has been identified for termination in response to the thread being located in the protected set and terminating the thread that has been identified for termination in response to the thread being located in the unprotected set.

In another exemplary embodiment, an apparatus is provided that is capable of providing termination of a thread in a virtual machine. In this regard, the apparatus includes a thread management module. The thread management module includes a classification element and a termination element. The classification element is capable of defining one or more of a protected set of code segments and an unprotected set of code segments. The termination element is capable of deferring termination of a thread that has been identified for termination in response to the thread being located in the protected set and terminating the thread that has been identified for termination in response to the thread being located in the unprotected set.

In another exemplary embodiment of the present invention, a computer program product and method for selectively executing finalizers of objects associated with a terminated application are provided. The computer program product and method include executable portions and operations, respectively, of determining whether objects associated with a terminated application are instantiated from one of a trusted class or an untrusted class, executing finalizers of objects determined to be instantiated from the trusted class, and discarding finalizers of objects determined to be instantiated from the untrusted class.

In another exemplary embodiment of the present invention, an apparatus for selectively executing finalizers of objects associated with a terminated application are provided. The apparatus includes a means for determining whether objects associated with a terminated application are instantiated from one of a trusted class or an untrusted class, a means for executing finalizers of objects determined to be instantiated from the trusted class, and a means for discarding finalizers of objects determined to be instantiated from the untrusted class.

In another exemplary embodiment of the present invention, an apparatus for selectively executing finalizers of objects associated with a terminated application are provided. The apparatus includes a processing element and a determining module. The determining module is configured to determine whether objects associated with a terminated application are instantiated from one of a trusted class or an untrusted class. The processing element is configured to execute finalizers of objects determined to be instantiated from the trusted class, and to discard finalizers of objects determined to be instantiated from the untrusted class.

Embodiments of the invention provide a method, apparatus and computer program product for providing safe termination of a thread in a virtual machine. As a result, operators may achieve a desirable level of isolation between applications with the full power and flexibility of Java or other applications for accessing and utilizing user interface and other device features.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a virtual machine according to an exemplary embodiment of the present invention;

FIG. 4 is a flowchart according to an exemplary method of providing safe termination of a thread in a virtual machine according to one embodiment of the present invention;

FIG. 5 illustrates a block diagram of portions of a virtual machine according to an exemplary embodiment of the present invention; and

FIG. 6 illustrates a flowchart of a method of selectively executing finalizers in accordance with an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

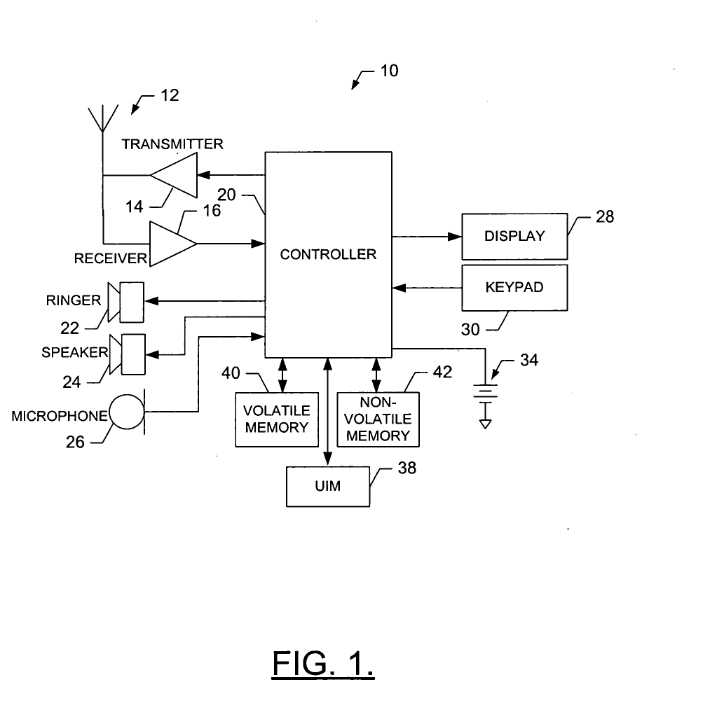

FIG. 1 illustrates a block diagram of a mobile terminal 10 that could embody and would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile television, laptop computers and other types of voice and text communications systems or computers, can readily employ the present invention. Furthermore, it should be understood that, although the present invention will be described in detail with respect to Java applications, the present invention may also be practiced with other applications such as, for example, applications written for operating systems such as Windows, Symbian, Unix and BREW, or other native applications.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third generation (3G) wireless communication protocol W-CDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example. Also, for example, the controller 20 may be capable of operating a software application capable of creating an authorization for delivery of location information regarding the mobile terminal 10, in accordance with embodiments of the present invention (described below).

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

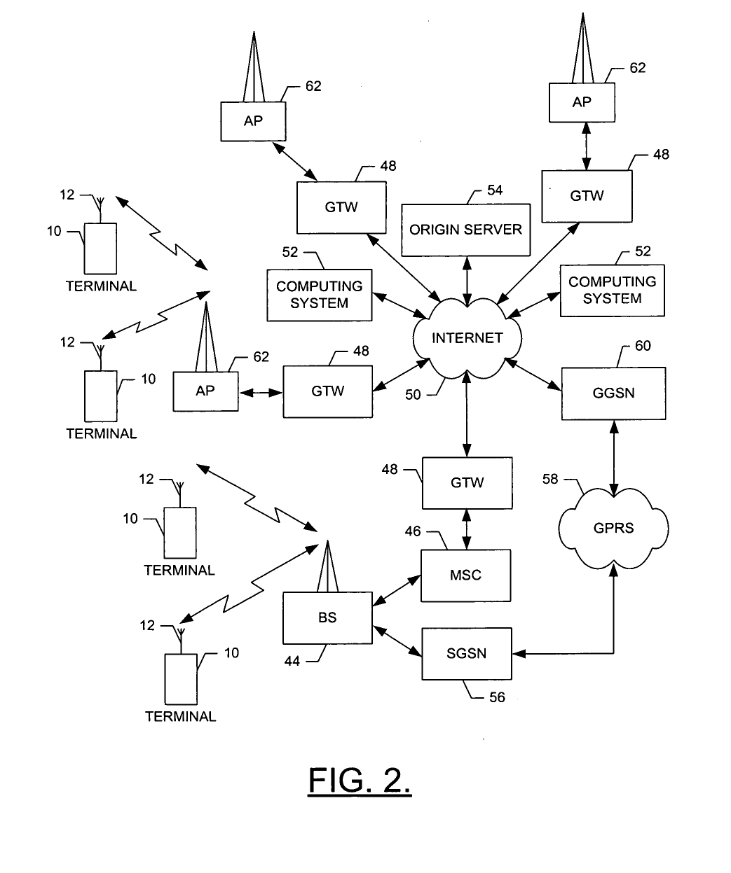

Referring now to FIG. 2, an illustration of one type of system that could embody and would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (b 1G), second-generation (2G), 2.5 G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5 G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

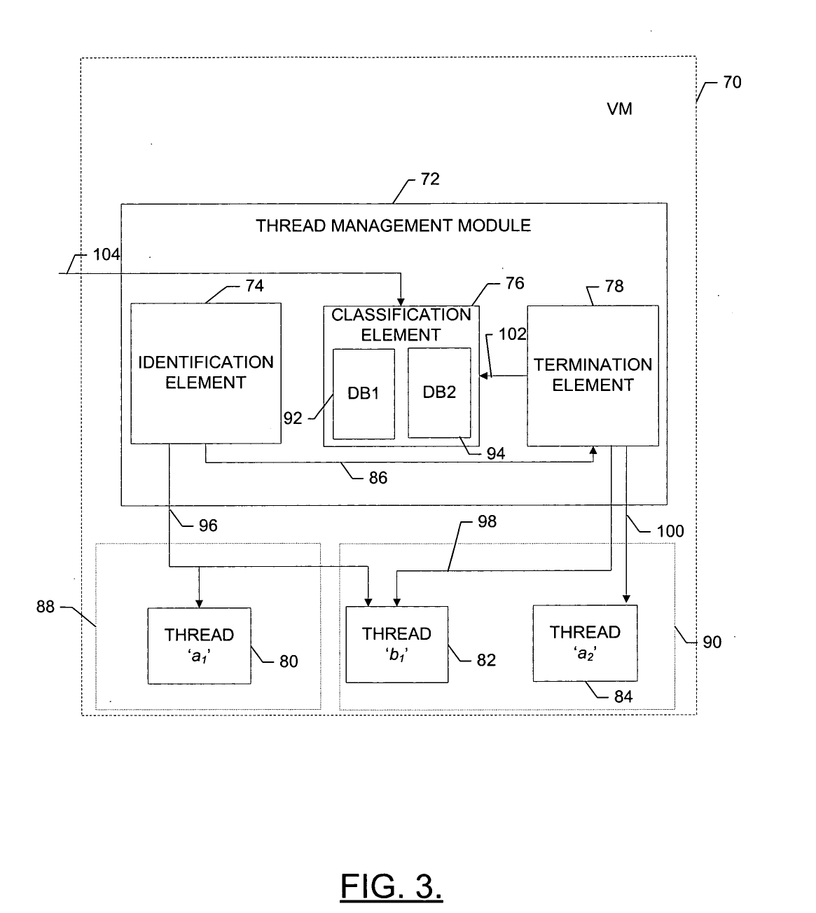

An exemplary embodiment of the invention will now be described with reference to FIG. 3, in which certain elements of a VM which may run on a framework of the mobile terminal 10 of FIG. 1 are shown in greater detail. The framework of the mobile terminal may include the operating system of the mobile terminal 10. It should be noted, however, that while FIG. 3 illustrates merely one example of a configuration of a thread termination module, numerous other configurations may also be used to implement embodiments of the present invention. It should also be noted that while the VM of FIG. 3 is a Java VM, any other operating system or VM may also be used. Furthermore, the VM of FIG. 3 may alternatively be embodied as any device or means embodied in either hardware, software, or a combination of hardware and software that is capable of managing code segments and discriminatorily terminating threads as described below. In an exemplary embodiment, however, the VM is embodied in software as instructions that are stored on a memory of the mobile terminal 10. Referring now to FIG. 3, a VM 70 according to an exemplary embodiment includes a thread management module 72. The thread management module 72 may be embodied as any device or means embodied in either hardware, software, or a combination of hardware and software that is capable of classifying code segments, identifying threads for termination, and terminating threads identified for termination when the threads are resident or located in a non critical area.

The thread management module may include an identification element 74, a classification element 76, and a termination element 78. The identification element 74 may be embodied as any device or means embodied in either hardware, software, or a combination of hardware and software that is capable of identifying threads that should be terminated. The classification element 76 may be embodied as any device or means embodied in either hardware, software, or a combination of hardware and software that is capable of classifying code segments as being either protected or unprotected at one or more of method, class or package levels. The termination element 78 may be embodied as any device or means embodied in either hardware, software, or a combination of hardware and software that is capable of terminating threads that have been identified as requiring termination and are located in a non critical area.

As shown in FIG. 3, the identification element 74 monitors each of multiple threads of the VM 70 over time. For example, the identification element 74 may monitor thread ‘a’ and thread ‘b’ at a first time (i.e., thread ‘a₁’ 80, thread ‘b₁’ 82) and thread ‘a’ at a second time (i.e., thread ‘a₂’ 84). The identification element 74 monitors each of the threads to determine if any of the threads should be terminated and identifies such threads for termination. Threads may be identified for termination in response to the identification element 74 determining that the thread belongs to an application that is not trusted, malicious or ill-behaving. A malicious or ill behaving application can be identified in several ways. For example, an application that is identified as having threads that consume large amounts of processing time, an application that allocates relatively very large amounts of memory space, and an application that generates relatively very large amounts of network traffic may each be identified as malicious or ill behaving applications. In other words, applications that are identified as being malicious or ill behaving are often associated with applications that exceed a consumption limit for a particular resource. Once a thread is identified for termination, a termination request 86 may be sent by the identification element 74 to the termination element 78. For example, if the identification element determines that both thread ‘a’ and thread ‘b’ belong to an application that should be terminated, the identification element 74 may send the termination request 86 to the termination element, identifying both thread ‘a’ and thread ‘b’ for termination.

The classification element 76 is capable of classifying code segments as being in either a protected set 88 or an unprotected set 90. Code segments may be classified at various levels, such as by method, class, package or combinations of the previously mentioned levels, as being in the protected set 88 or the unprotected set 90. In an exemplary embodiment, code segments in the protected set 88 are those code segments associated either a method, class or package with code segments that handle critical resources. Critical resources may be, for example, core applications, trusted applications, global state of the VM and a framework, or well-tested applications. However, any definition a user chooses for identifying the protected set 88 may be used. In an exemplary embodiment, code segments in the unprotected set 90 include all code segments associated with non-critical regions. In other words, the unprotected set 90 includes all code segments that are not a part of the protected set 88. It should be noted that a package that is defined as being part of the protected set 88 may include classes, methods and code segments that are handling non-critical resources. However, if the package is classified as protected, all classes, methods and code segments within the package are also protected. In other words, if a package is unprotected then all code segments do not handle critical resources, but if a package is protected, it is possible that only some code segments handle critical resources. A similar statement could be made regarding protected and unprotected classes or methods.

In an exemplary embodiment, classification of the code segments as either being in the protected set 88 or the unprotected set 90 may be accomplished by classifying code segments as pertaining to critical or non critical resources on a selected level. As stated above, such classification may occur on a method level, a class level, or a package level. For example, a first database 92 may contain or list the protected set 88 of methods, classes, packages or combinations of the preceding associated with the critical resources. Meanwhile, a second database 94 may contain or list the unprotected set 90 of methods, classes, packages or combinations of the preceding associated with the non-critical resources. Alternatively, either the first database 92 or the second database 94 may be populated by defining resources as being associated with either the critical or non critical resources, and the other of the first or second database 92 or 94 will be populated by all remaining resources. The first and second databases 92 and 94 may be stored in the classification element 76. Alternatively, the first and second databases 92 and 94 may be stored elsewhere and accessed by the classification element 76, or the protected and unprotected sets 88 and 90 may be stored in a single database in which case the protected set 88 is the complement of the unprotected set 90. Accordingly, methods, classes and packages may be identified as belonging to the protected and unprotected sets 88 and 90 without changing or modifying codes of applications or Java application programming interfaces (APIs).

A flag may be inserted on the method or class level to classify the method or class to the protected or unprotected set. For example, the flag may be inserted into the structure of a method, a class, or every class in a package that indicates whether the method, class or every class in a package is in the protected set 88 or the unprotected set 90. The flag may be determined using partitioning information or guidelines regarding partitioning between the protected and unprotected sets 88 and 90 when the class, method, etc., structure is created when the class, method, etc., is loaded. Such partitioning information can be provided to the VM 70 in several ways. For example, the class, method, etc., files may include the partitioning information, a separate resource file may include the partitioning information, or the Java or other operating system policy system may include the partitioning information to define the protected set 88.

Such an exemplary embodiment as that described above may be useful in an environment in which an operating system (OS) in use is capable of providing support for deferred thread termination. For example, if the VM 70 uses a native portable operating system interface (POSIX) thread library for Java threads, OS provided thread features could be used for representing state changes of a thread (i.e. movement of a thread from the unprotected set 90 to the protected set 88 or vice versa) and thread termination. For example, state changes could be performed with a “pthread_setcancelstate( )” method and thread termination could be performed using a “pthread_cancel( )” method. Accordingly, the OS will not terminate a thread that has been identified for termination if the thread is in a critical or protected region (i.e., the protected set 88). Rather, the OS will wait until a state change occurs and the thread that has been identified for termination is located in an unprotected region (i.e., the unprotected set 90), at which time the OS will terminate the thread. Meanwhile, if the thread that has been identified for termination is originally located in an unprotected region, the thread may be terminated without delay.

In an alternative exemplary embodiment, the OS does not provide support for deferred thread termination, but terminating a thread from another is still available. According to this exemplary embodiment, deferred thread termination may be accomplished by having the identification element 74 insert a flag or other marker into the native representation of a thread to indicate that the thread should be terminated if the thread could not be terminated immediately since it was in the protected set, otherwise the thread is terminated immediately without using the inserted flag. When there is a state change of the thread (i.e. movement of a thread from the protected set 88 to the unprotected set 90), the inserted flag is checked by the thread itself to see whether it should terminate itself.

Flag insertion according to an exemplary embodiment is shown by line 96 in FIG. 3. Accordingly, the termination element 78 may monitor threads for the flag or other marker and terminate the thread immediately if the thread is located in the unprotected region (i.e. in the unprotected set 90) or defer termination until the thread changes state by moving into an unprotected region if the thread is located in the protected region (i.e., in the protected set 88) when the flag is detected. In an exemplary embodiment, the termination element 78 may query all threads upon each state change to determine if the flag is present and termination is required.

In yet another alternative embodiment, in which the OS provides no support for thread termination, deferred thread termination may be accomplished by having the identification element 74 conduct flag insertion 96 or another marker as described above and the thread may be instructed to check itself for the flag and, if the flag is detected, the thread may then terminate itself when the flagged thread is located in the unprotected set 90.

In order to avoid the problems of prior termination methods, the termination element 78 determines whether or not threads identified for termination are located in a non-critical area. Determination as to whether or not threads identified for termination are located in a non-critical area may be accomplished via consulting the classification element 76 as shown by line 102. Accordingly, the termination element 78 may recognize a particular thread as being identified for termination (for example, by means of the flag described above) and then determine whether the particular thread is in a protected or unprotected region (for example, by consulting the databases described above) and terminate the particular thread if or when the particular thread is located in the unprotected set 90. For example, the termination element may query each thread upon a state change of the thread, to determine if the thread has been identified for termination. State changes can occur, for example, before calling a method, after returning from a method, and during exception propagation.

FIG. 3 shows an example of the process described above. For example, assume both thread ‘a’ and thread ‘b’ have been identified for termination. However, at a first time thread ‘a’ (i.e., thread ‘a₁’ 80) is located in the protected set 88, and thread ‘b’ (i.e., thread ‘b₁’ 82) is located in the unprotected set 90. Accordingly, the termination element 78 may then terminate thread ‘b₁’ 82 (shown by line 98), but defers termination of thread ‘a’ until a state change occurs. Thus, when thread ‘a’ changes state at a second time (i.e., thread ‘a₂’ 84), the termination element 78 may terminate thread ‘a₂’ 84 as shown by line 100. For example, the termination element 78 may call a “destroy( )” method in order to terminate a thread. It should be noted that any connection or signal shown in FIG. 3, is merely exemplary and not limiting. Furthermore, FIG. 3 may not show each and every connection or signal as only those required to explain operation of an exemplary embodiment of the present invention have been described in detail.

In an exemplary embodiment, as shown in FIG. 3, the classification element 76 may permit dynamic alteration of the protected and unprotected sets 88 and 90. In other words, the protected and unprotected sets 88 and 90 may be redefined on the fly as indicated by redefinition input 104. Accordingly, there is no need to hardcode which sets are protected or unprotected. Thus, for example, if a particular method is received from an external source, it may initially be classified as unprotected. However, for example, after a certain period of time or after suitable testing, the particular method may be redefined to be classified as protected. It should be noted that although the redefinition input 104 is shown as originating external to the VM 70, the origin of the redefinition input 104 may be any acceptable source including internal to the VM 70.

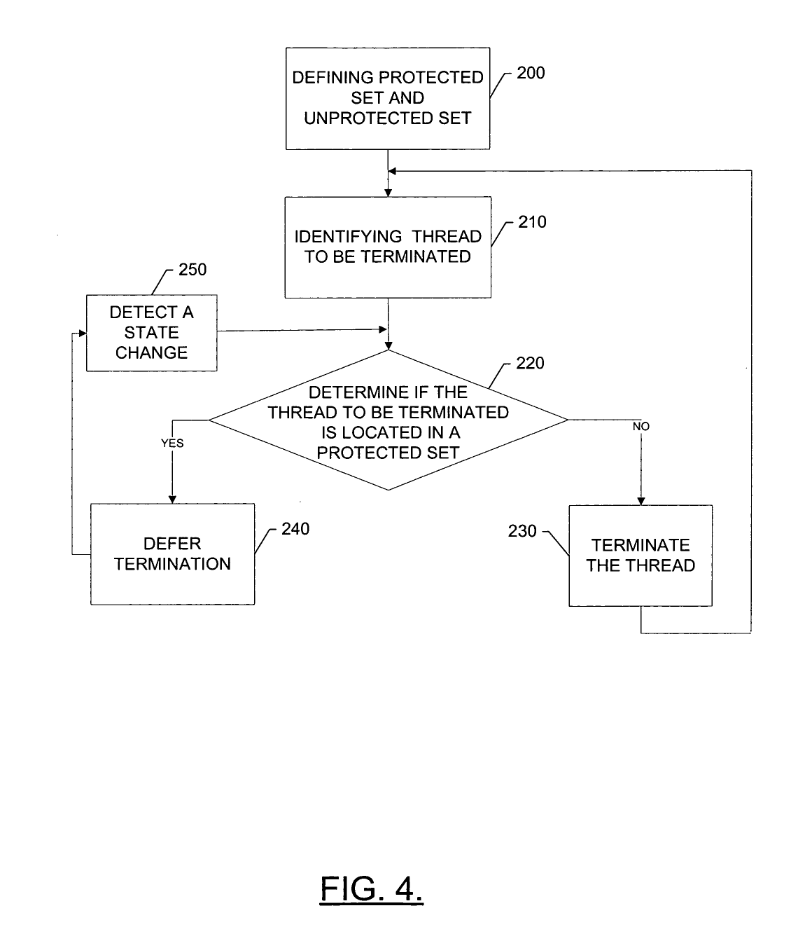

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing safe termination of a thread in a virtual machine includes defining protected and unprotected sets by classifying code segments as protected or unprotected at operation 200. At operation 210, an application (and associated threads) that should be terminated is identified. Each thread associated with the application is identified for termination. At operation 220, a determination is made as to whether or not a thread identified for termination is currently located in the protected set. If the thread identified for termination is currently not located in the protected set, then the thread identified for termination is terminated at operation 230. If the thread identified for termination is currently located in the protected set, then termination is deferred at operation 240. An optional operation of detecting a state change may be included at operation 250. Otherwise, the method may include repeated determination at selected intervals at operation 220 until the thread identified for termination is located in the unprotected set and terminated at operation 230.

Due to the problems discussed in the background above, it may be desirable to selectively execute finalizers of objects based on whether the objects were instantiated from a trusted class or an untrusted class. In this regard, a trusted class may be defined as a class that is known through experience or otherwise to be trustworthy in that the class is not “buggy” and will not operate maliciously. For example, a trusted class may be identified based on results from testing to determine if the class should be trusted. Meanwhile, an untrusted class may be defined as any class that is not a trusted class. In an exemplary embodiment, after termination of an application, finalizers of objects instantiated in particular classes are selectively executed. For example, finalizers of objects instantiated from trusted classes are executed without exception. Accordingly, when an application is terminated, finalizers are executed to clear any native resources allocated and associated with objects from trusted classes during a lifetime of the objects. However, finalizers of objects instantiated from classes that are not fully trusted by the platform are discarded and destroyed without taking any further steps. Accordingly, finalizers that may place the platform in an endless loop or other harmful state may be discarded without being executed, while finalizers of objects that are instances of trusted classes may be executed without exception.

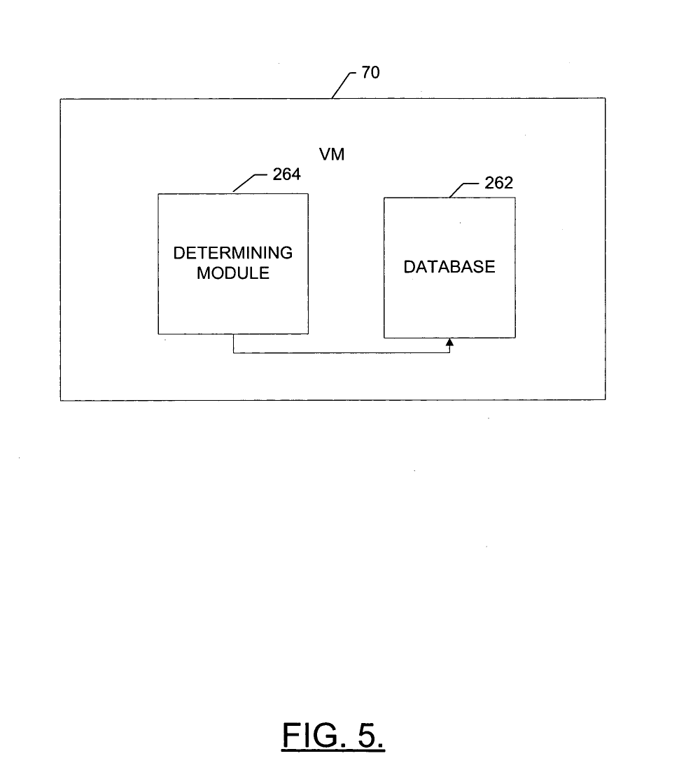

In order to implement selective execution of finalizers as indicated above, it may be desirable to register all classes that are trusted. Accordingly, a registration may be maintained, for example, in a database such as the first or second databases 92 or 94 or database 262 of FIG. 5, which is accessible by a class determining module 264 of the VM 70. The determining module 264 may be any means or device embodied in hardware, software or a combination of hardware and software that is capable of determining whether an object is instantiated from a trusted class or an untrusted class. For example, the determining module 264 may access the database 262 which is includes a stored list of trusted classes. Alternatively, the classes themselves may include an internal registration, for example, a signature of a deployment package can determine whether the classes of the deployment package are trusted or untrusted.

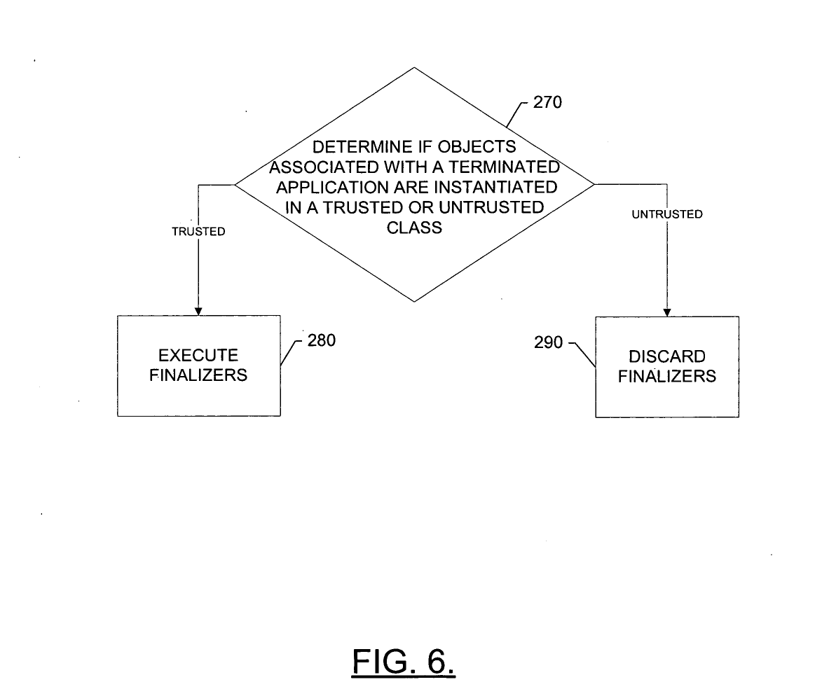

FIG. 6 includes a flowchart of a method of selectively executing finalizers in accordance with an exemplary embodiment of the present invention. The method of FIG. 6 may be employed, for example, after termination of a thread at operation 230 of FIG. 4. However, the method of FIG. 6 could also be employed independently upon termination of any application by any mechanism. As shown in FIG. 6, an exemplary method of selectively executing finalizers includes determining whether objects associated with a terminated application are instantiated from one of a trusted class or an untrusted class at operation 270. At operation 280, finalizers are executed if the class is determined to be trusted. At operation 290, finalizers are discarded if the class is determined to be untrusted.

It should be noted that although embodiments of the present invention have been described above in the context of a mobile terminal, any computing device may employ embodiments of the present invention. For example, embodiments of the present invention may be employed on any computer or server including servers capable of communication with relatively large numbers of clients.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of providing termination of threads in a virtual machine, the method comprising:
defining one or more of a protected set of code segments and an unprotected set of code segments;
deferring termination of a thread that has been identified for termination in response to the thread being located in the protected set; and
terminating the thread that has been identified for termination in response to the thread being located in the unprotected set.

2. A method according to claim 1, further comprising identifying the thread for termination with a flag.

3. A method according to claim 2, wherein terminating the thread is performed responsive to a flagged thread being located in the unprotected set.

4. A method according to claim 1, wherein defining the protected and unprotected sets comprises defining the code segments according to one or more of:
a method;
a class; and
a package.

5. A method according to claim 4, wherein defining the protected and unprotected sets comprises defining the one or more of the method, class and package as being in a respective one of the protected and unprotected sets responsive to partition information.

6. A method according to claim 1, wherein terminating the thread further comprises terminating the thread in response to an indication of a change of state of the thread from the protected set to the unprotected set.

7. A method according to claim 1, further comprising dynamically altering a definition of one or more of the protected set and the unprotected set.

8. A method according to claim 1, further comprising:
determining whether objects associated with a terminated application are instantiated from one of a trusted class or an untrusted class;
executing finalizers of objects determined to be instantiated from the trusted class; and
discarding finalizers of objects determined to be instantiated from the untrusted class.

9. A computer program product for providing termination of threads in a virtual machine, the computer program product comprising at least one computer-readable storage medium having computer-readable program code portions stored therein, the computer-readable program code portions comprising:
a first executable portion for defining one or more of a protected set of code segments and an unprotected set of code segments;
a second executable portion for deferring termination of a thread that has been identified for termination in response to the thread being located in the protected set; and
a third executable portion for terminating the thread that has been identified for termination in response to the thread being located in the unprotected set.

10. A computer program product according to claim 9, further comprising a fourth executable portion for identifying the thread for termination with a flag.

11. A computer program product according to claim 10, wherein the third executable instruction is also for terminating the thread that has been identified for termination responsive to a flagged thread being located in the unprotected set.

12. A computer program product according to claim 9, wherein the first executable portion further includes instructions for defining the code segments according to one or more of:
a method;
a class; and
a package.

13. A computer program product according to claim 12, wherein the first executable portion further includes instructions for defining the one or more of the method, class and package as being in an appropriate one of the protected and unprotected sets responsive to partition information.

14. A computer program product according to claim 9, wherein the third executable portion further includes instructions for terminating the thread in response to an indication of a change of state of the thread from the protected set to the unprotected set.

15. A computer program product according to claim 9, further comprising a fourth executable portion for dynamically altering a definition of one of the protected set and the unprotected set.

16. A computer program product according to claim 9, further comprising:
a fourth executable portion for determining whether objects associated with a terminated application are instantiated from one of a trusted class or an untrusted class;
a fifth executable portion for executing finalizers of objects determined to be instantiated from the trusted class; and
a sixth executable portion for discarding finalizers of objects determined to be instantiated from the untrusted class.

17. An electronic device capable of providing termination of threads, the device comprising:
a framework supporting a virtual machine capable of executing applications via threads,
wherein the virtual machine comprises a thread management module including:
a classification element capable of defining one or more of a protected set of code segments and an unprotected set of code segments; and
a termination element capable of:
deferring termination of a thread that has been identified for termination in response to the thread being located in the protected set; and
terminating the thread that has been identified for termination in response to the thread being located in the unprotected set.

18. A device according to claim 17, wherein the thread management module further comprises an identification element capable of identifying the thread for termination with a flag.

19. A device according to claim 18, wherein the termination element is further capable of terminating the thread that has been identified for termination responsive to a flagged thread being located in the unprotected set.

20. A device according to claim 17, wherein the protected and unprotected sets are defined according to one or more levels including:
a method,
a class, and
a package.

21. A device according to claim 17, wherein the one or more of the method, class and package are defined as being in a respective one of the protected and unprotected sets responsive to partition information.

22. A device according to claim 21, wherein the partition information is receivable during operation of the virtual machine to dynamically alter a definition of one or more of the protected set and the unprotected set.

23. A device according to claim 17, wherein the termination element is further capable of terminating the thread in response to an indication of a change of state of the thread from the protected set to the unprotected set.

24. A device according to claim 17, wherein the framework is Java.

25. A device according to claim 17, wherein the virtual machine further comprises a determining module configured to:
determine whether objects associated with a terminated application are instantiated from one of a trusted class or an untrusted class;
execute finalizers of objects determined to be instantiated from the trusted class; and
discard finalizers of objects determined to be instantiated from the untrusted class.

26. An apparatus capable of providing termination of threads, the apparatus comprising:
a thread management module including:
a classification element capable of defining one or more of a protected set of code segments and an unprotected set of code segments; and
a termination element capable of:
deferring termination of a thread that has been identified for termination in response to the thread being located in the protected set; and
terminating the thread that has been identified for termination in response to the thread being located in the unprotected set.

27. An apparatus according to claim 26, wherein the thread management module further comprises an identification element capable of identifying the thread for termination with a flag.

28. An apparatus according to claim 27, wherein the termination element is further capable of terminating the thread that has been identified for termination responsive to a flagged thread being located in the unprotected set.

29. An apparatus according to claim 26, wherein the protected and unprotected sets are defined according to one or more levels including:
a method,
a class, and
a package.

30. An apparatus according to claim 26, wherein the one or more of the method, class and package are defined as being in a respective one of the protected and unprotected sets responsive to partition information.

31. An apparatus according to claim 30, wherein the partition information is receivable during operation of the virtual machine to dynamically alter a definition of one or more of the protected set and the unprotected set.

32. An apparatus according to claim 26, wherein the termination element is further capable of terminating the thread in response to an indication of a change of state of the thread from the protected set to the unprotected set.

33. An apparatus according to claim 26, further comprising a determining module configured to:
determine whether objects associated with a terminated application are instantiated from one of a trusted class or an untrusted class;
execute finalizers of objects determined to be instantiated from the trusted class; and
discard finalizers of objects determined to be instantiated from the untrusted class.

34. An apparatus capable of providing termination of threads, the apparatus comprising:
a classification means for defining one or more of a protected set of code segments and an unprotected set of code segments; and
a termination means for:
deferring termination of a thread that has been identified for termination in response to the thread being located in the protected set; and
terminating the thread that has been identified for termination in response to the thread being located in the unprotected set.

35. An apparatus according to claim 34, further comprising an identification means for identifying the thread for termination with a flag.

36. An apparatus according to claim 35, wherein the termination means is capable of terminating the thread that has been identified for termination responsive to a flagged thread being located in the unprotected set.

37. A method of selectively executing finalizers of objects associated with a terminated application, the method comprising:
determining whether objects associated with a terminated application are instantiated from one of a trusted class or an untrusted class;
executing finalizers of objects determined to be instantiated from the trusted class; and
discarding finalizers of objects determined to be instantiated from the untrusted class.

38. A method according to claim 37, further comprising an initial step of registering classes as being one of the trusted class or the untrusted class.

39. A method according to claim 38, wherein registering comprises examining a signature of a deployment package.

40. An apparatus capable of selectively executing finalizers of objects associated with a terminated application, the apparatus comprising a processing element and a determining module,
wherein the determining module is configured to determine whether objects associated with a terminated application are instantiated from one of a trusted class or an untrusted class, and
wherein the processing element is configured to execute finalizers of objects determined to be instantiated from the trusted class and discard finalizers of objects determined to be instantiated from the untrusted class.

41. An apparatus according to claim 40, wherein the determining module is further configured to register classes as being one of the trusted class or the untrusted class.

42. An apparatus capable of selectively executing finalizers of objects associated with a terminated application, the apparatus comprising:
a means for determining whether objects associated with a terminated application are instantiated from one of a trusted class or an untrusted class;
a means for executing finalizers of objects determined to be instantiated from the trusted class; and
a means for discarding finalizers of objects determined to be instantiated from the untrusted class.

43. An apparatus according to claim 42, further comprising a means for registering classes as being one of the trusted class or the untrusted class.

44. A computer program product for selectively executing finalizers of objects associated with a terminated application, the computer program product comprising at least one computer-readable storage medium having computer-readable program code portions stored therein, the computer-readable program code portions comprising:
a first executable portion for determining whether objects associated with a terminated application are instantiated from one of a trusted class or an untrusted class;
a second executable portion for executing finalizers of objects determined to be instantiated from the trusted class; and
a third executable portion for discarding finalizers of objects determined to be instantiated from the untrusted class.

45. A computer program product according to claim 44, further comprising a fourth executable portion for registering classes as being one of the trusted class or the untrusted class.
